(19) United States
(12) Patent Application Publication
(10) Pub. No.: US 2022/0146325 A1
(43) Pub. Date: May 12, 2022

(54) SYSTEM WITH HOLDER AND PIERCING FOOD THERMOMETER, AND HOLDER

(71) Applicant: VORWERK & CO. INTERHOLDING GMBH, Wuppertal (DE)

(72) Inventors: Leon Seydel, Wuppertal (DE); Felix Thies, Wuppertal (DE); Matthias Stein, Mülheim an der Ruhr (DE); Christoph Buggeln, Düsseldorf (DE); Philipp Charopoulos, Ratingen (DE)

(21) Appl. No.: 17/522,375

(22) Filed: Nov. 9, 2021

(30) Foreign Application Priority Data
Nov. 9, 2020 (DE) 102020214049.9

(51) Int. Cl. G01K 1/14

(52) U.S. Cl. CPC G01K 1/14; G01K 2207/06

(57) ABSTRACT

A versatile system includes a food thermometer and a holder for holding the food thermometer. The holder includes two different holding means by which the food thermometer can be held in two different holding positions. The present disclosure also relates to a holder for the system.

### CROSS-REFERENCE TO RELATED APPLICATIONS

This application claims priority to and benefit of German Patent Application Number 102020214049.9, filed Nov. 9, 2020, the disclosure of which is hereby incorporated by reference in its entirety.

### FIELD OF TECHNOLOGY

The present disclosure relates to a system having a holder and food thermometer, as well as, a holder for the food thermometer.

### BACKGROUND

A food thermometer is a thermometer with which the temperature of a food is to be measured. A piercing food thermometer is intended and suitable for being pierced into a food in order to be able to measure the temperature inside the food. Such a thermometer therefore has a tip in order to be able to be pierced into meat, for example. A temperature-sensitive sensor of the food thermometer is then located at the tip in order to be able to measure the internal temperature of meat. Examples of such food thermometers are known from the publications EP 0687866A1, U.S. Pat. No. 6,568,848 B1 and U.S. Pat. No. 7,075,442 B2.

If a food thermometer is pierced into meat, the meat can hold the thermometer. However, holding the food thermometer through a food is not possible if the consistency of the food is not sufficiently firm. There is therefore a need for a holder that can hold a food thermometer in a desired position.

A magnetic holding of a food thermometer is known from the publications US 2017/138797 A1 and US 2017/138798 A1. The publications EP 2 896 330 A1 and EP 2 896 329 A1 disclose an adapter for fixing a food thermometer to a cooking utensil. The food thermometer then does not have to be held in a desired position by a food.

It is the task of the systems and methods of the present disclosure to provide a versatile system comprising a holder and a food thermometer. The present disclosure also relates to a holder for such a food thermometer.

### SUMMARY

A system with a food thermometer and a holder for holding the food thermometer serves to solve the task.

The holder comprises two different holding means by which the food thermometer can be held in two different holding positions. The system is versatile because two different holding positions are possible.

The food thermometer may be inserted into a holding means, for example, to be held by the holding means. If the holder comprises two different holding means, the thermometer can be held in at least two different ways. There are, thus, at least two different holding positions for the thermometer.

The two holding means can hold the thermometer at different angles. This may enable to insert the thermometer into a food from different directions while it is held by the holder. The position of the holder does not have to be changed for this. Through this, it may be possible that the thermometer can be held in a differently inclined manner by the two holding means of the holder. The two holding means can then be used to select two differently inclined positions for the thermometer.

For example, the thermometer can be held at different heights by the two holding means of the holder. The two holding means can then be used to select two different heights. It is thus possible that the food thermometer can be inserted into a food at a different height when it is held by the holder.

### BRIEF DESCRIPTION OF THE DRAWINGS

The figures show

FIG. 1: Section through a system with a food thermometer and a holder;

FIG. 2: view of the system rotated by 90° compared to FIG. 1;

FIG. 3: System with thermometer inserted into a food from above;

FIG. 4: view of the system rotated by approx. 70° compared to FIG. 1;

FIG. 5: System with thermometer inserted into food from the side;

FIG. 6: Top view of holder;

FIG. 7: Top view of holder with thermometer and fixing to vessel wall;

FIG. 8: three-dimensional view of a second configuration;

FIG. 10: holder from FIG. 9 with thermometer in upright position;

FIG. 11: system with holder serving as handle;

FIG. 12: System with holder fixed to vessel wall;

FIG. 13: System with thermometer inserted into a food from the side;

FIG. 14: Top view of holder from FIG. 13;

FIG. 15: System with thermometer inserted into a food from the side; and

FIG. 16: System with cylindrical container.

### DETAILED DESCRIPTION

FIG. 1 shows a section through a system with a food thermometer 1 and a holder 2 for holding the food thermometer 1. The holder 2, which consists for example of an elastomer, may comprise a foot 3 and a neck 4. If the foot 3 stands on a horizontal base 5, then the neck 4 projects upwards from the foot 3.

The food thermometer 1 may be pin-like. The food thermometer 1 may have a tip 6 at one end. The food thermometer 1 can have a handle 7 at the other end. The handle 7 may be tapered and widen toward the end. The housing of the food thermometer 1 may consist of metal, with the exception of the handle 7. However, the housing of the food thermometer 1 may also consist entirely of metal. The handle 7 preferably consists of a heat-resistant plastic. The food thermometer 1 may have a tip that can be pierced into a food. A temperature sensor may be located at the tip 6 of the food thermometer. A battery may be located at the tip of the food thermometer. When the tip of the food thermometer is inserted into a food, the battery is well protected from heat since the interior of a food is generally cooler than the temperature inside an associated food preparation vessel. However, a battery may also be protected from heat by the handle 7 and thus then be located within the handle 7. The battery may be rechargeable. A further temperature sensor may be located approximately in the middle of the food thermometer 1 or at the handle 7, so that a second temperature can be measured outside of a food. The food thermometer may have electronics to evaluate a signal from a temperature sensor. The food thermometer may comprise transmitting means for wirelessly sending a temperature signal to a receiving device.

The tip 6 may be an end inserted into a passage 8 of the holder 2. The tip 6 can stand on the base 5. In the placed state of the holder 2 shown in FIG. 1, the thermometer 1 stands vertically from the horizontal base 5. The thermometer together with the holder can thus be kept ready in a space-saving manner. The passage 8 is a holding means of the holder 2 to hold the food thermometer 1 in a desired position. The tip 6 can therefore also be inserted through the passage 8.

FIG. 1 shows that in the view shown, the width of foot 3 can be greater than the height of holder 2. Seen from the neck 4, the foot 3 can project equally far to the left and to the right. Thus, in this view, the passage 8 passes through the center of the foot 3. The diameter of the passage 8 may be such that the handle 7 cannot be pushed through the passage 8, or cannot be pushed through completely. In particular in this embodiment, the holder may also be used to allow a thermometer to be easily pulled back out of a food. The holder therefore preferably consists of a material which is a poor conductor of heat compared to metal, such as an elastomer or other plastic.

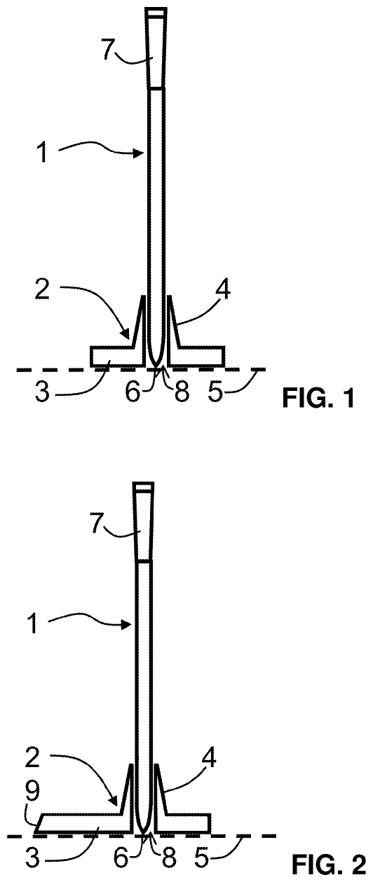

FIG. 2 shows a view of the system rotated by 90° about a vertical axis compared to FIG. 1. In this view, the passage 8 no longer passes through the center of the foot 3. Instead, the foot 3 protrudes significantly further laterally from the neck 4 on the left side compared to the right side of the foot 3. The further laterally protruding side of the foot 3 may comprise an inclined flat support surface 9. The foot 3 can therefore protrude further laterally to one side than to the opposite side.

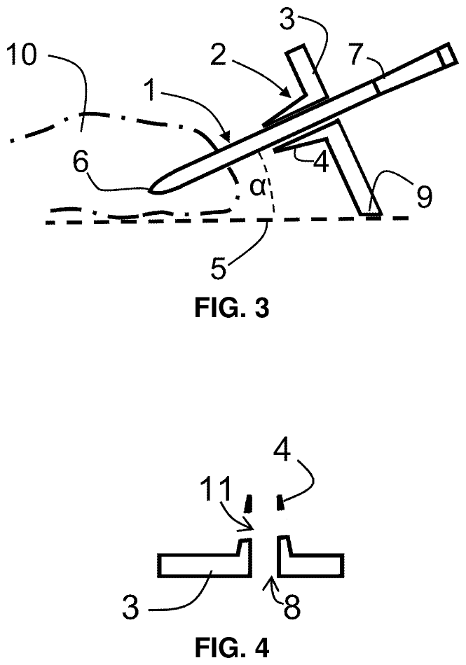

In FIG. 3 the function of the support surface 9 is shown. Compared to FIGS. 1 and 2, the tip 6 is inserted through the passage 8 in the opposite direction, namely into a bread dough 10. The support surface 9 now stands on the base 5 and thereby stabilizes the position of the thermometer 1. The support surface can be inclined in such a way that the thermometer 1 encloses an angle α with the base 5, which can be 30°-60°. The whole area of the support surface 9 can then be in contact with the base 5. Because the foot 3 projects relatively far in the direction of the support surface 9 viewed from the neck 4, the thermometer 1 can be inserted from an upper position into a food, such as a bread dough 10. Initially, a bread dough 10 is not firm enough to reliably hold a thermometer 1. As shown in FIG. 3, the holder 2 can sufficiently stabilize the position of a thermometer 1 using the support surface 9 even in such foods as bread dough 10.

FIG. 4 shows a view of the holder 2 which is rotated by approx. 70° about the aforementioned vertical axis compared to FIG. 1. In this view, the passage 8 does not pass through the center of the foot 3. However, the foot 3 protrudes less laterally towards the left side compared to the case of FIG. 2. Also, the inclined flat support surface 9 is now no longer visible. Instead, a passage 11 is now visible, which runs exclusively through the neck 4, through which the thermometer 1 can be inserted.

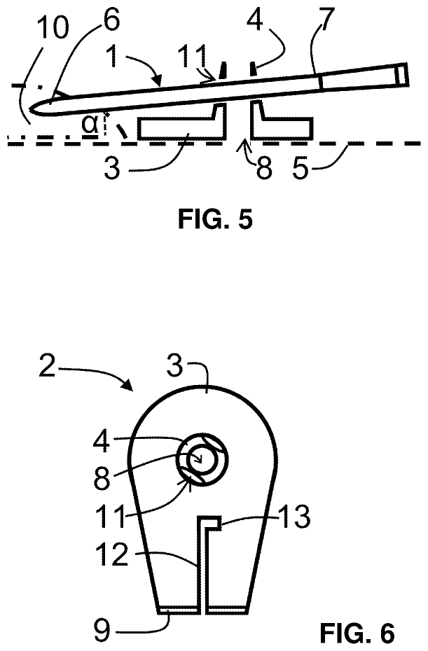

As shown in FIG. 5, an end 6 of the thermometer 1 can be inserted through the passage 11. The passage 11 is thus a holding means for the thermometer 1. The thermometer 1 then runs, for example as shown, almost horizontally and encloses an angle α of, for example, no more than 15° with a horizontal base 5. The thermometer 1 can then be located relatively close to the base 5 from the beginning. The thermometer 1 can then be pierced laterally into a food 10. The thermometer 1 now requires no further support to be able to maintain the position shown, because the thermometer is essentially horizontal. The thermometer 1 is in a position suitable for directly measuring temperatures of relatively thin foods 10 regardless of their consistency.

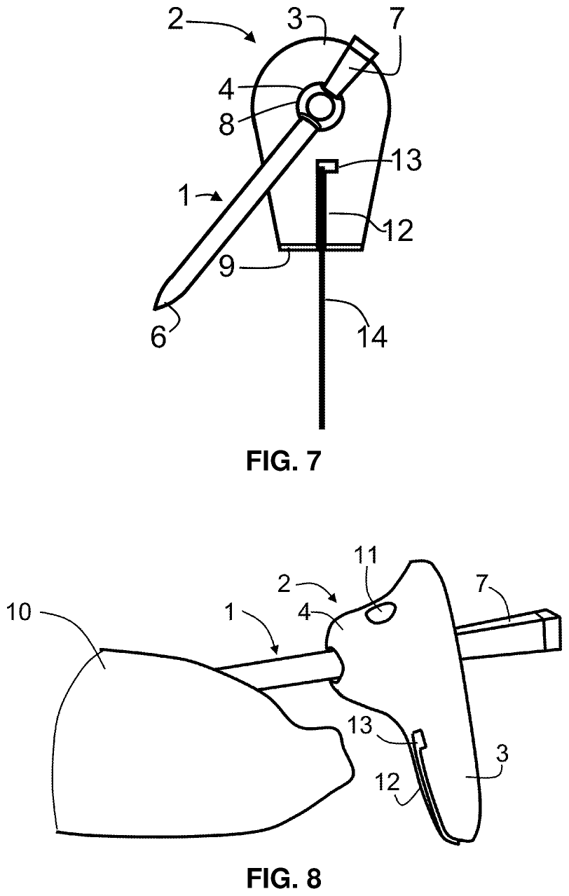

FIG. 6 shows a top view of the holder 2. The foot 3 protrudes from the neck 4 to such an extent that a finger can be placed on the foot 3 to the left and right of the neck 4, respectively. The holder 2 can thus be easily grasped, for example in order to be able to easily pull a thermometer out of a food 10. The foot 3 may be provided with a slot 12 having one open end at the support surface 9. The other end of the slot 12 may have a widening 13. The slot 12 and widening 13 may be L-shaped as shown. This allows the right leg shown in FIG. 6 adjacent the slot 12 to be more easily elastically bent than the leg shown on the left when the holder 2 consists of an elastically bendable material. A vessel wall 14 shown in FIG. 7 can then be inserted into the slot in such a way that the holder is fixed to the vessel by a clamping effect. The clamping effect is assisted by the widening 13, as this facilitates spreading of the legs. The holder 2 can be connected to the vessel wall 14 in a non-slip manner by a clamping effect. A thermometer 1 may then have been inserted through the passage 11 such that the thermometer 1 extends into the vessel comprising the vessel wall 14. FIG. 7 illustrates that the thermometer 1 may then enclose an angle of about 40° to 50° with the inner wall 14. A temperature in the upper region of the vessel comprising the vessel wall 14 can now be measured.

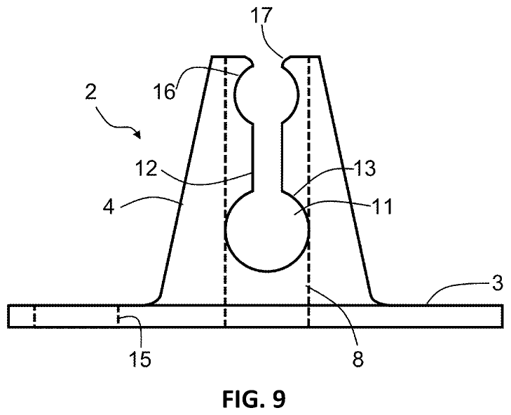

FIG. 8 shows a second, three-dimensionally illustrated configuration of a holder 2 and a thermometer 1 held by the holder. The situation shown in FIG. 8 corresponds to the situation shown in FIG. 3. The comparison of FIG. 8 with FIG. 3 makes it clear that the thermometer 1 can also be inserted almost horizontally, for example into a piece of meat 10. The end with the slot 12 of the foot 3 can nevertheless be placed on a base for stabilization. No flat support surface is required for this. Placing the ends of the two legs separated by the slot 12, as indicated in FIG. 8, may be sufficient. Since the two ends are spaced apart, they can stabilize the position of the thermometer 1 well.

FIG. 9 schematically shows a side view of a third configuration of a holder 2 for holding a food thermometer 1. The holder 2, which consists for example of an elastomer, can again comprise a foot 3 and a neck 4. If the foot 3 stands on a horizontal base 5, then the neck 4 projects upwards from the foot 3, preferably vertically. The foot 3 can be circular when viewed from above. The foot 3 can be polygonal when viewed from above. The foot 3 can be square, for example, when viewed from above.

In the third configuration, the width or diameter of the foot 3 can also be greater than the height of the holder 2. Seen from the neck 4, the foot 3 can also protrude equally far to the left and to the right in this third configuration. The neck 4 can thus be arranged centrally on the foot 3. There may be a passage 8 indicated by dashed lines, which may pass through the center of the foot 3 in the view shown in FIG. 9. The diameter of the passage 8 may be such that the handle 7 of a thermometer 1 cannot be pushed through the passage 8, or cannot be pushed through completely. A pointed end 6 of a thermometer 1, for example, can be inserted into the passage 8 and also through it. The handle 7 can then act as a stop to prevent the thermometer 1 from being pushed completely through the passage 8.

As shown in FIG. 9, a passage 11 may pass through the neck 4. A for example pointed end 6 of a thermometer 1 can be inserted through the passage 11. Subsequently, the thermometer 1 may be held horizontally or at least approximately horizontally by the holder 2 when the holder 2 is placed as shown in FIG. 9. The handle 7 of a thermometer 1 can then in turn act as a stop, which can prevent a thermometer 1 from being pushed completely through the passage 11.

A passage 15 can pass through the foot 3, which passage also serves as a holding means for a thermometer 1. This holding means 15 is intended to hold a thermometer 1 in particular when the slot 12 is connected to a vessel wall. A for example pointed end 6 of a thermometer 1 can be inserted through the passage 15. The handle 7 can then serve as a stop to prevent the thermometer 1 from being pushed completely through the passage 15.

The third configuration of the holder 2 may comprise a slot 12. The slot 12 again serves to fix the holder 2 to a vessel wall. The slot 12 may extend into the neck 4 from above, as shown in FIG. 9. The slot 12 then comprises an open end at the upper side of the neck 4.

The slot 12 may have a passage 16 near its entrance opening 17. The diameter of passage 16 may be smaller than the diameter of the other three passages 8, 11 and 15. When a tip or pointed end 6 of a thermometer 1 is pushed into the passage 16, the two legs of the slot 12 are bent apart. A thermometer 1 is then held in a clamping manner. The passage 16 then acts together with the legs of the slot 12 like a clamp. Alternatively, a thermometer 1 can be pushed through the entrance opening 17 from above until the thermometer 1 is held in the region of the passage 16 like a clamp.

The passages 11 and/or 16 can be inclined in such a way that a thermometer 1 is not held horizontally by the respective passage 11, 16, but runs obliquely towards the base. This applies when the holder 2 is placed as shown in FIG. 9. The passages 11 and/or 16 may run horizontally if the holder 2 is placed on a horizontal base. Thus, the passages 11 and/or 16 may then run parallel to the base.

The slot 12 may include an outwardly widening entrance opening 17 to facilitate, for example, sliding a vessel wall into the slot 12.

The passage 11 can serve a double purpose if it serves as a circular widening 13 for the slot 12, as shown in FIG. 9. The passage 11 then forms a widened bottom of the slot 12.

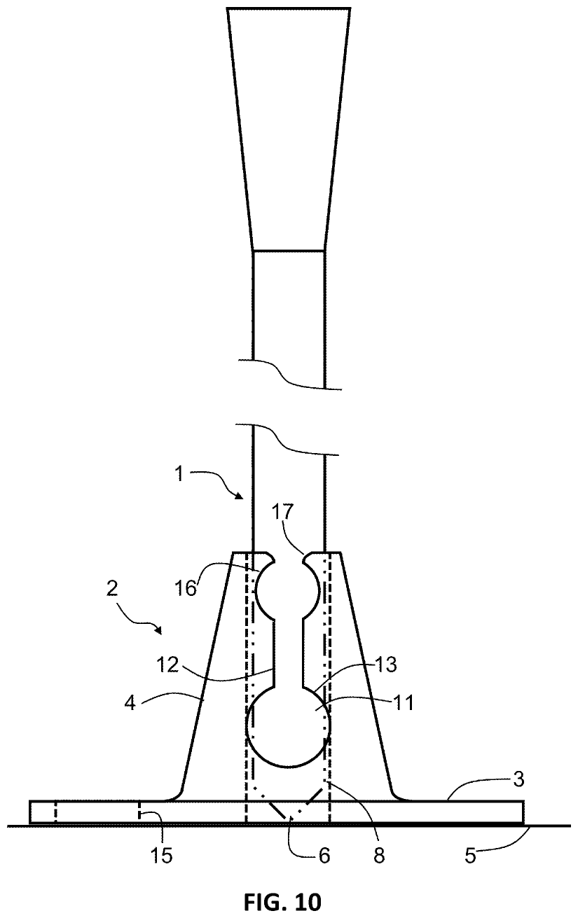

FIG. 10 shows the holder 2 from FIG. 9. The holder 2 is placed with its foot 3 on a horizontal base 5. A thermometer 1 is inserted with its tip 6, i.e. its pointed end, into the passage 8. The base 5 prevents the tip 6 from being inserted through the passage 8. The thermometer 1 extends vertically upwards. The thermometer 1 is in a parking position. It can be stored in the parking position together with the holder 2 to save space in a cabinet. The thermometer 1 can be placed together with the holder 2 close to a cooktop to save space and thus be available together with the holder 2 within reach during a cooking process.

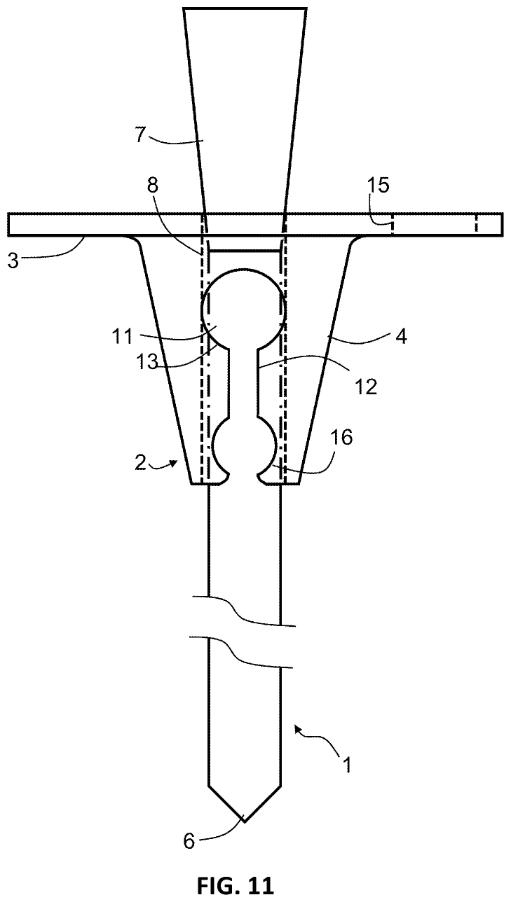

FIG. 11 shows the holder 2 from FIGS. 9 and 10. Compared to FIG. 10, the tip 6 of the thermometer 1 has first been inserted into the passage 8 in the opposite direction. Then the tip 6, and thus the thermometer 1, has been inserted further through the passage 8 and to the handle 7. Since the handle 7 widens conically towards the end, it acts as a stop and can be held frictionally in the passage 8. The holder 2 now additionally serves as a heat-insulating handle for the thermometer 1, if the holder 2 consists of a heat-insulating material such as plastic. The plastic is preferably elastic, so that the handle 7 can be partially pushed into the passage 8 in such a way that the handle 7 is held frictionally in the passage 8. Alternatively or complementarily, the handle 7 may consist of an elastic material so that a frictional connection to a passage can be established. In particular, the foot 3 of the holder 2 may be grasped by fingers of one hand and therefore used to allow to easily withdraw the thermometer 1 from a food.

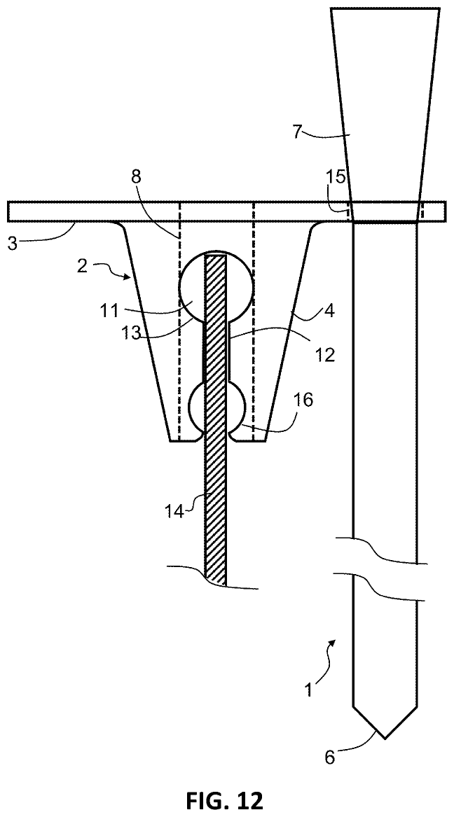

FIG. 12 shows the holder 2 from FIGS. 9 to 11 fixed to a vessel wall 14 shown in section. For this purpose, the vessel wall 14 is pushed into the slot 12 of the holder 2. The tip 6 of the thermometer 1 has been inserted through the passage 15 in the foot 3 of the holder 2. The widened handle 7 of the thermometer 1 prevents the thermometer 1 from slipping through the passage 15. The tip 6 now extends into the vessel having the vessel wall 14. The thermometer 1 can therefore measure the internal temperature in a cooking vessel or food preparation vessel having the vessel wall 14. The thermometer 1 can also extend into a food that is located in the cooking vessel or food preparation vessel with the vessel wall 14.

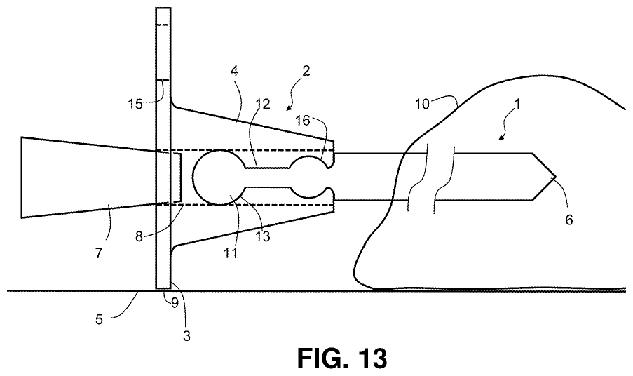

FIG. 13 shows a temperature measurement of a food 10 by means of a thermometer 1 and a holder 2. In contrast to the holders 2 shown in FIGS. 9 to 12, the holder 2 shown in FIG. 13 has a straight running support surface 9 at the side. When the tip 6 of the thermometer 1 is inserted through the passage 8 and into a food 10, the holder 2 may be placed on the support surface 9. Placing the holder 2 on the support surface 9 stabilizes the position of the thermometer 1 during temperature measurement, since the straight line of the support surface 9 can rest in a straight line on a base. However, the support surface 9 can also be concavely curved. The two ends of the concave curvature can then rest on a base and thus stabilize the position of the thermometer 1.

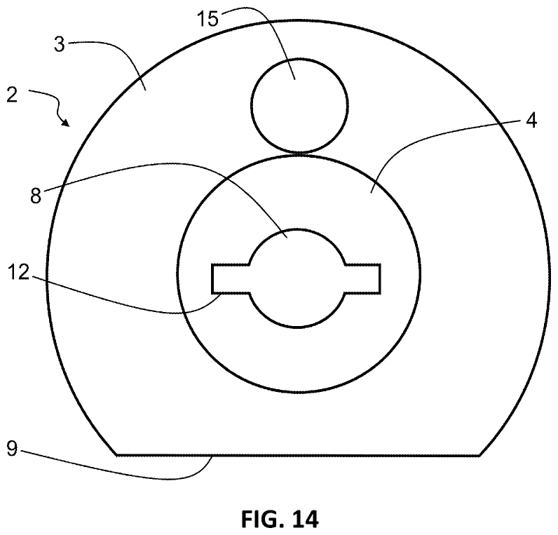

FIG. 14 schematically shows a view of the holder 2 from FIG. 13. FIG. 14 illustrates that, viewed from above, the foot 3 is not circular because there is a straight running support surface 9 at the side. The support surface 9 provides for a deviation from a circular shape. The support surface 9 does not have to be flat to have a stabilizing effect. For stabilization, it is only important that the support surface 9 runs in a straight line when viewed from above, as shown in FIG. 14. Otherwise, the support surface 9 can run in a uniform arc shape, for example, as is the case with a cylinder.

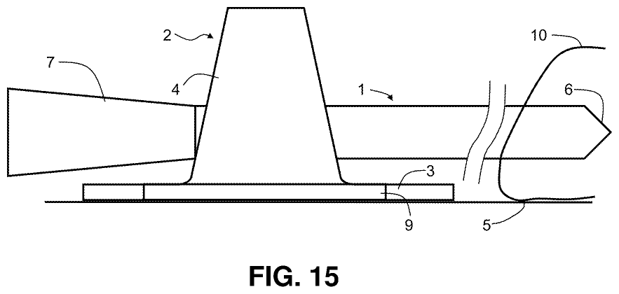

FIG. 15 schematically shows the holder 2 and the thermometer 1 of FIGS. 13 and 14. The tip 6 of the thermometer 1 is inserted through the passage 11 and into a food 10.

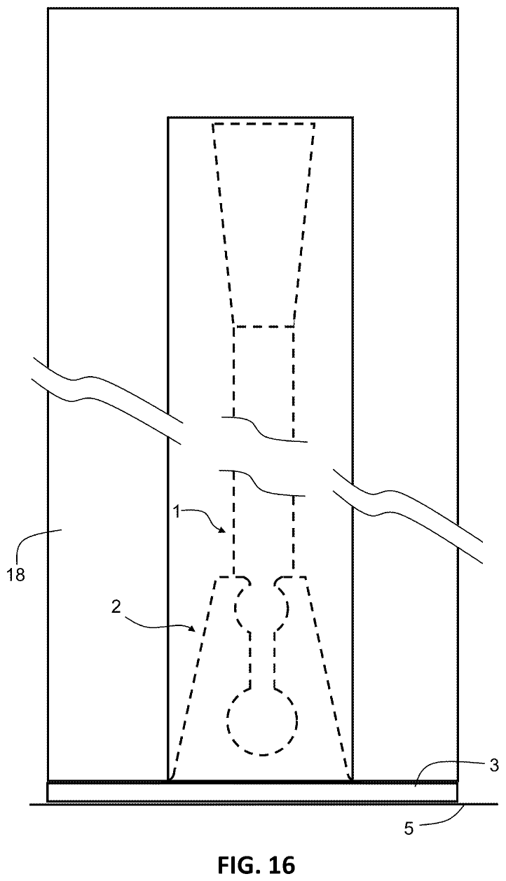

The system shown in FIG. 16 comprises a container 18. The container 18 may be cylindrical in shape. The container 18 may be closed at one end, as shown on the upper side in FIG. 16. The holder 2 may be adapted to the container opening such that the holder 2 may be a cap (closure cap) for the container 18. The thermometer 1 can then be in the container 16. The container 18 may thus protect the thermometer 1 housed in the container 18 from external influences. The system with the container 18 can be stored in a space-saving and protected manner.

All of the holders 2 shown in at least FIGS. 1 to 3 and 6 can serve as a cap. However, the configurations of holders 2 shown in FIGS. 9 to 15 are particularly suitable.

In one embodiment, the container 18 can inductively recharge the battery of the thermometer. In this case, the container 18 comprises charging electronics configured for inductive charging. In one embodiment, the container 18 may comprise a battery, for example, to recharge the battery of the thermometer 1. A battery of the container 18 may alternatively or additionally serve to supply power to its own electronics. In one embodiment, the container 18 may be connected to an external power source to be able to charge the battery of the thermometer 1 and/or, if applicable, the battery of the container 18. In one embodiment, the battery can be removed from the container 18, for example, to allow the battery to be charged thereafter.

In one embodiment, the container 18 may comprise a wireless transmitting and/or receiving unit to be able to wirelessly send data to the thermometer 1 and/or to be able to wirelessly receive data from the thermometer 1. In one embodiment, the container 18 may comprise a display on which a measured temperature of the thermometer 1 can be displayed. A wireless transmitting and/or receiving unit of the container 18 may be configured to be able to receive data from the thermometer 1 only over short distances, and to be able to send the data over longer distances to an external control device such as a food processor. In this way, the container 18 may exchange data with the thermometer 1 via Bluetooth, for example, or at least receive data from the thermometer. The container 18 can then exchange data with the food processor via Wi-Fi, for example. The container 18 can thus serve as an interface to minimize the energy consumption of the thermometer 1 during operation. The food processor may then be configured such that a food preparation device in which the thermometer 1 measures temperatures is controlled via the food processor. However, the container 18 may also receive and send data only via Bluetooth or only via Wi-Fi, for example, to be able to be an interface. The container 18 may have a computing device to perform computing tasks and thereby relieve the thermometer of computing tasks. It is advantageous to use the container 18 for computing tasks rather than the thermometer to minimize the power consumption of the thermometer. Indeed, the container 18 can, for example, unproblematically have its own comparatively large battery and/or, for example, can be unproblematically connected to an external power source.

Other configurations of a holder 2 are also possible. For example, a further configuration may be different from the third configuration shown in FIG. 9 because the passage 16 passing through the neck 4 is not present.

In addition to the passage 15 and the passage 8, there may be a third passage which passes through the foot 3. It is then advantageous, for reasons of space, that the passage 15 and the third passage are arranged such that the passage 8 shown in FIG. 14 is located between the other two passages. The three passages can thus be arranged along a straight line.

In the case of three passages passing through the foot 3, it is expedient for reasons of space that the passage 15 is not arranged opposite the support surface 9 at the outer circumference as shown in FIG. 14. Instead, it is then advantageous that the three passages are arranged along an imaginary straight line running parallel to the support surface 9 shown in FIG. 14. The passage 15 is then located, for example, to the left of the passage 8 shown in FIG. 14 and the third passage is located to the right of the passage 8 shown in FIG. 14.

There may also be more than three passages passing through the foot 3, for example four passages. There may be only two passages present at the outer circumference of the foot. Between the two passages which are then on the outside there may be a blind hole into which the food thermometer can be inserted. The blind hole may end at the base of the foot and serve to allow the food thermometer 1 to be placed vertically as shown in FIGS. 1, 2 and 10 when the placement surface of the foot 3 is placed on a flat surface. Thus, the food thermometer cannot then be pushed through the foot 3 because the blind hole is closed at the foot 3.

The slot 12 shown in FIG. 14 need not run from right to left and thus parallel to the support surface 9. Instead, it may be expedient for the slot 12 shown in FIG. 14 to run from top to bottom and thus perpendicular to the support surface 9 shown in FIG. 14. This course of the slot 12 is preferable, for example, if there are three passages arranged along said imaginary straight line as previously described. Instead of three passages, there may be two passages and a blind hole arranged along a line.

If, in addition to the passage 8 shown in FIG. 14 or in addition to the blind hole replacing the passage 8, there are two further passages, i.e. the passage 15 and a third passage, then it is advantageous that the three passages can hold a food thermometer 1 in three different ways. If a food thermometer 1 is held by the middle passage 8, then the food thermometer 1 extends, for example, as shown in FIG. 13, parallel to the direction of extension of the neck 4 and thus perpendicular to the placement surface of the foot 3. If a food thermometer 1 is held by the second passage 15, then the food thermometer 1 encloses, for example, a first acute angle with the direction of extension of the neck 4, thus deviating from what is shown in FIG. 12. Thus, the food thermometer 1 is then not parallel to the direction of extension of the neck 4, as shown in FIG. 12. If a food thermometer 1 is held by the third passage, then the food thermometer 1 encloses, for example, a second acute angle with the direction of extension of the neck 4. The second acute angle is then larger than the first acute angle, for example.

There may also be only one passage through the base and, in addition, a blind hole for vertical placement. The passage is then preferably aligned such that the thermometer does not run perpendicular to the placement surface of the foot 3 through the passage.

In FIG. 14, passages with a round cross-section are shown. However, it is also possible for one or more passages to have an angular cross-section. For example, all three passages mentioned may have a square cross-section. This is particularly preferable if the handle 7 also has a square cross-section such that the handle can be held non-rotatably by each passage, preferably held in a clamping manner. The food thermometer 1 may further have different cross-section, such as a circular cross-section.

The cross-section of the handle 7 preferably becomes continuously larger towards the adjacent end of the food thermometer 1, so that the handle can only be partially inserted into a passage. The passage 15 and/or said third passage may be such that a food thermometer 1 which has been inserted into one of the two passages can be pivoted by more than 5°, preferably by more than 10°, and such pivoting movement is no longer possible when the handle 7 has been inserted into a said passage in the maximum possible manner. To achieve this, a passage may have, for example, a square or circular cross-section at one side, which becomes increasingly elongated towards the other side. For example, the cross-section of the passage on the other side can then be rectangular or a differently shaped oblong hole. This further increases the possible applications.

The holder 2 and/or the handle 7 may consist of a temperature-resistant plastic. Preferably, the plastic is selected such that it can be exposed to usual maximum oven temperatures of up to at least 200° C. or up to at least 220° C.

By means of the holder, the thermometer can be held in a desired position in order to be able to reliably measure, for example, the inside of a food by means of an inserted tip of the food thermometer. The holder can also ensure that a second temperature sensor of the food thermometer is reliably located outside the food, in order to be able to measure not only the temperature of the food directly, but also, at the same time, the temperature in a food preparation vessel in which the food is located. A first temperature sensor of the thermometer is then located, for example, at one end of the thermometer and a second temperature sensor may then be located in the middle of the thermometer or at another end of the thermometer.

A holding means may be a passage through which an end of the food thermometer may be inserted for holding. Preferably, only one end of the food thermometer can be inserted therethrough. For example, the diameter of the other end of the food thermometer may be too large to be able to be inserted therethrough. A passage can be implemented with little technical effort. Due to its simple geometry, a passage can be easily cleaned, for example, by means of a dishwasher. A passage also multiplies the number of possible holder positions, since the thermometer can be inserted into a passage to different extents. Advantageously, this further increases the selection options for positioning the thermometer. Suitable temperatures can thus be measured in a further improved manner.

The diameter of a passage can be selected so that there is a clearance fit between the thermometer and the passage when the thermometer is held by the passage. One end of the thermometer can then be inserted very easily through the passage.

The diameter of a passage can be selected so that there is a transition fit between the thermometer and the passage when the thermometer is held by the passage. Particularly reliable holding is then possible. However, a somewhat greater amount of force is usually required to insert one end of the thermometer through the passage.

The diameter of a passage is generally not greater than 20 mm, preferably not greater than 10 mm. The diameter of a passage is generally at least 3 mm, preferably at least 5 mm. The surface of the passage can consist of a non-slip material, such as an elastomer, in order to be able to hold the thermometer particularly reliably.

In one embodiment, the holder comprises a foot for placing the holder on a base. The foot can have a flat surface on its underside for placing it on a base. The foot can have knobs on its underside, for example, in order to be able to place it on a base. The foot allows the holder to be placed firmly on a horizontal base.

In one embodiment, a holding means can hold the food thermometer vertically or at least substantially vertically when the holder is placed on a horizontal base by the foot. A thermometer can therefore be kept ready to hand in a space-saving manner by means of the holder.

In one embodiment, a holding means can hold the food thermometer horizontally or at least substantially horizontally when the foot is placed on a horizontal base. This position is primarily for being able to laterally insert a thermometer into a food. At the same time, the holder can then hold the food thermometer. Thus, the position of the thermometer does not have to be held by the food. This also applies if the holding means is formed by a passage.

In one embodiment, the food thermometer may form an angle of less than 20°, preferably less than 15°, particularly preferably less than 10°, with a horizontal line when the food thermometer is held substantially horizontally by the holding means. Substantially horizontally means that the food thermometer is slightly inclined, i.e. makes an angle greater than zero with the horizontal line.

In one embodiment, the length and/or width of the foot are greater than the height of the holder. This results in a low center of gravity for the holder. As a result, the holder can be placed particularly stably on its foot. In addition, the holder can be stored in a space-saving manner.

The length and/or width of the foot is generally no more than 100 mm, preferably no more than 80 mm. The height of the holder is then generally less than 100 mm, preferably less than 80 mm. The length and/or width of the foot are preferably at least 20 mm, particularly preferably at least 30 mm.

In one embodiment, the foot comprises a laterally straight running side. The straight running side may comprise a straight running edge. The straight running side may be rounded in the transverse direction. The straight running side is such that it may be placed on a plane with a straight line. This may allow the thermometer to be inserted into a food and supported on a base by means of the straight running side. The position of a thermometer can thus be stabilized by the straight running side.

In one embodiment, the foot comprises a support surface on the side, for example a flat support surface, and then also a straight running side. The support surface is then such that it can be placed completely on a plane. This allows the thermometer to be inserted into a food and supported against a base by means of the support surface. The position of a thermometer can therefore be stabilized by the support surface.

However, the support surface does not have to be straight and/or flat. What is important is that the support surface can rest on a base in at least two different locations in such a way that the holder is secured against tilting. This can be achieved, for example, by a concave course of the support surface. The two different locations are thus spaced apart. The distance should be at least 1 cm. If the support surface cannot prevent tilting, then there is no support surface in accordance with the present disclosure.

In one embodiment, the holder comprises a further holding means by which the holder can be fixed to a wall of a food vessel. The holder can then be attached to a vessel wall. In this embodiment, the holder can hold the thermometer such that the thermometer extends into the associated vessel in order to be able to measure at least the internal temperature of the vessel.

The further holding means may comprise a slot with an open end. An edge of a vessel wall can be inserted into the slot so that the holder is fixed to the vessel in this way. Fixing can be achieved, for example, by a clamping effect when the slot can be elastically pushed apart. This is the case, for example, if the further holding means consists of an elastomeric material. Preferably, the holder then consists entirely of an elastomeric material. In this way, the manufacturing effort can be kept low.

The slot is preferably widened at the end which is opposite the open end. This facilitates bending the slot apart so that the slot can be fixed to a vessel wall by clamping effect. In addition, the further holding means can be avoided from being damaged by bending the slot apart in an improved manner. The widening can be circular.

The slot and widening may be L-shaped to taper a leg adjacent to the slot in the region of the widening. Bending the slot apart by bending substantially only one leg can thereby be achieved. If substantially only one leg is bent for fixing due to an L-shape, the other leg can rest against an inner wall of a vessel in a positionally stable manner. This allows the thermometer to reach into the interior of a vessel in a particularly reproducible manner.

Preferably, the foot provided for placing the holder comprises the slot. This is particularly advantageous if the dimensions of the foot are comparatively large compared to the height of the holder. The foot provides sufficient space to allow a sufficiently large slot to be provided.

In one embodiment, the food thermometer encloses an angle of 20° to 70°, preferably 30° to 60°, with a wall of a food vessel when the holder is fixed to the wall of the food vessel by the further holding means and the thermometer is held by a holding means. By such an angle, the food thermometer can reach into the food vessel to a suitable extent and can then also have a sufficient distance to the wall of the food vessel. This ensures that an internal temperature of the food vessel can be measured and not, for example, a temperature at a possibly cooler wall area.

The present disclosure also relates to a holder for a system. The holder may be as previously described. The holder may comprise a foot for placing the holder. The holder may comprise two passages as holding means for holding the food thermometer. The holder may comprise a slot as further holding means. The slot may comprise an open end to allow a vessel wall to be pushed into the slot to fix the holder to a wall of a food vessel.

The holder is preferably manufactured in one piece. This ensures above all that the cleaning effort can be kept to a minimum. The holder can consist of a plastic that is heat-resistant up to at least 100° C., preferably up to at least 180° C. The material of which the holder consists is preferably heat-resistant up to at least 250° C.

The food thermometer and the holder are generally separate components. To provide a versatile system, two different holding positions are not necessary. For example, a combination of only one holding means and foot of the holder allow versatility. Thus, the task of the present disclosure can also be solved by a holder comprising only one holding means for the thermometer.

In one embodiment, the holder may comprise more than two different holding means for the thermometer. For example, the holder can comprise three holding means for the thermometer. The food thermometer can then be held in at least three different holding positions, for example. For example, there may be three different passages forming the three holding means. At least one end of the thermometer can then be inserted through each of the three passages.

However, the holder can also comprise four different holding means for the thermometer. For example, there may be four different passages for the thermometer.

If there are at least two holding means for the thermometer, it can be useful that a first holding means is realized by a passage and a second holding means by a clamp, in order to achieve a particularly versatile system. The clamp may be provided in order to be able to hold the thermometer securely even in an inclined position. The bore can then be provided for holding the thermometer at least approximately horizontally.

Generally, the thermometer can be inserted into both inlet openings of a passage and then through the passage. This means that there are already two different holding positions possible for each passage. Since the end of the thermometer can generally be pushed through each passage to a different extent, the number of possible holding positions is further multiplied. It also follows that the holder can have only one passage as a holding means, thereby creating a versatile system of holder and thermometer. A clamp as holding means also allows many different holding positions and thus a versatile system.

In one embodiment, the thermometer can be held by a passage by force fit or friction. This can be achieved by the thermometer having a widening such that the widened portion can be held by force fit or friction when the widened portion has been at least partially moved into a passage. The widened portion may be an end of the thermometer. For example, the widened portion may be cone-shaped.

Other combinations of the above features are also possible to achieve the desired versatility. The aforementioned holding means can also be implemented in other ways. A holding means may be provided in the form of a magnet. A holding means may comprise a magnet. A holding means provided for holding the thermometer may be a clamp. A holding means may consist of two shells that are hingedly connected to each other. The shells may be folded closed for holding the thermometer. In the closed state, the shells can be latched, for example, in order to be able to hold a thermometer in a particularly stable manner.

1. A system comprising,
a food vessel having a vessel wall arranged to extend upwardly to a free edge,
a food thermometer having a tip end, the food thermometer configured to determine the temperature of food in contact with the tip end, and
a holder configured to hold the food thermometer in a first position with the tip end of the food thermometer below the rest of the thermometer in contact with a food arranged on a horizontal base upon which the holder is also supported and in a second position with the tip end of the food thermometer below the rest of the thermometer in contact with a food in the food vessel below the level of the free edge of the vessel wall,
wherein the holder is shaped to include a support surface configured to be placed in contact with the horizontal support surface at a location spaced apart from the food arranged on the horizontal base when the food thermometer is in the first position, a slot with an open end that extends from the support surface into the holder and that receives the vessel wall when the holder holds the food thermometer is in the second position, a first holding means for supporting the food thermometer in the first position when the support surface is in contact with the horizontal surface, and a second holding means for supporting the food thermometer in the second position when the vessel wall is received in the slot.

2. The system of claim 1, wherein the holder includes (1) a foot that includes the support surface and into which the slot is formed and (2) a neck that protrudes from the foot, the first holding means is provided by a first passage formed in the holder, and the second holding means is provided by a second passage formed through the neck.

3. The system of claim 2, wherein the first passage is formed through the foot and the neck of the holder.

4. The system of claim 3, wherein the first passage is perpendicular to and intersects with the second passage.

5. The system of claim 1, wherein the foot is provided by a planar member having a bottom side, a top side, and the support surface that extends between the bottom side and the top side, and
wherein the support surface forms an acute angle with the bottom side of the foot so that when placed in contact with the horizontal support surface the thermometer is supported by the first holding means is arranged in the first position so as to support the tip end of the food thermometer below the rest of the thermometer.

6. The system of claim 5, wherein the support surface and the first holding means are shaped so that the food thermometer forms an angle with the horizontal base of between 30° and 60° when the thermometer is in the first position.

7. A system comprising a food thermometer and a holder for holding the food thermometer, wherein the holder includes two different holding means configured to selectively receive the food thermometer to hold the food thermometer in two different holding positions.

8. The system of claim 7, wherein one of the two different holding means is a passage configured to receive an end of the food thermometer to hold the food thermometer.

9. The system of claim 8, wherein the holder includes a foot configured to position and retain the holder on a base.

10. The system of claim 9, wherein another one of the two different holding means is configured to hold the food thermometer vertically when the holder is placed on a horizontal base by the foot.

11. The system of claim 7, wherein one of the two different holding means is adapted to hold the food thermometer horizontally when the foot is placed on a horizontal base.

12. The system of claim 11, wherein the food thermometer encloses an angle of less than 20°, preferably less than 15°, with a horizontal line when the food thermometer is held horizontally by the holding means.

13. The system of claim 12, wherein a length and/or a width of the foot is greater than the height of the holder.

14. The system of claim 13, wherein the foot includes a support surface on a first side.

15. The system of claim 7, wherein the holder comprises a further holding means and is adapted to be selectively fixed to a wall of a food vessel.

16. The system of claim 15, wherein the further holding means defines a slot with an open end, and wherein the slot widens at an end opposite to an open end.

17. The system of claim 7, wherein the food thermometer encloses an angle of 30° to 60° with a wall of a food vessel when the holder is fixed to the wall of the food vessel by the further holding means and the food thermometer is held by a holding means.

18. The system of claim 7 further comprising a container and the holder can be a cap for the container when the thermometer is located in the container.

19. The system of claim 7 further comprising a foot for placing the holder, two passages for holding the food thermometer and a slot comprising an open end for fixing the holder to a wall of a food vessel.

20. The system of claim 19, wherein the holder is manufactured in one piece and consists of plastic.
